(19) United States
(12) Patent Application Publication
(10) Pub. No.: US 2010/0301530 A1
(43) Pub. Date: Dec. 2, 2010

(54) Fluid-filled type active vibration damping device and manufacturing method thereof

(75) Inventors: Hironori Koyama, Kasugai-shi (JP); Koichi Hasegawa, Kasugai-shi (JP); Atsushi Muramatsu, Komaki-shi (JP); Mutsumi Muraoka, Aichi-gun (JP); Satoshi Umemura, Kamo-gun (JP); Atsushi Urayama, Shioya-gun (JP); Hirozumi Kon, Utsunomiya-shi (JP)

Correspondence Address: OLIFF & BERRIDGE, PLC, P.O. BOX 320850, ALEXANDRIA, VA, 22320-4850, US

(73) Assignees: TOKAI RUBBER INDUSTRIES, LTD., KOMAKI-SHI (JP); KEIHIN CORPORATION, TOKYO (JP)

(21) Appl. No.: 12/801,148

(22) Filed: May 25, 2010

(30) Foreign Application Priority Data
May 29, 2009 (JP) 2009-130347

(51) Int. Cl. F16F 13/16; B23P 13/00; F16F 15/027

(52) U.S. Cl. 267/140.14; 29/896.9

(57) ABSTRACT

A fluid-filled type active vibration damping device including a vibration damping device main unit, an oscillation member, and an actuator. The actuator is constituted by an electromagnetic actuator having a stator that includes a coil fixed to a second mounting member while having a movable member linearly displaceable relative to the stator when the coil is energized. A shaft member is provided for connecting the movable member and the oscillation member with each other. A connecting portion is provided for attaching the shaft member to the movable member while permitting the shaft member to tilt as well as to undergo displacement in an axis-perpendicular direction with respect to the movable member. A displacement preventing portion is provided for fastening the movable member and the shaft member to each other by preventing tilt as well as displacement in the axis-perpendicular direction due to the connecting portion.

### INCORPORATED BY REFERENCE

The disclosure of Japanese Patent Application No. 2009-130347 filed on May 29, 2009 including the specification, drawings and abstract is incorporated herein by reference in its entirety.

### BACKGROUND OF THE INVENTION

1. Field of the Invention

The present invention pertains to a fluid-filled type vibration damping device that utilizes flow action of a fluid filling the interior; and relates in particular to a fluid-filled type active vibration damping device that exhibits active vibration damping effect through energization from the outside, and to a method for manufacturing the same.

2. Description of the Related Art

Vibration damping devices, which are designed for installation between components making up a vibration transmission system in order to provide vibration damped linkage to these components, are known in the prior art. These devices utilize vibration damping effect on the basis of factors such as internal friction of the rubber elastic body. Further, as one type of vibration damping devices, also known generally are fluid-filled type vibration damping devices that include a fluid chamber formed within the interior with a non-compressible fluid filled therein, which utilize vibration damping effect based on resonance action etc. exhibited by the non-compressible fluid flowing through an orifice passage. Moreover, with the aim of realizing higher vibration damping ability in the fluid-filled type vibration damping devices, there has been proposed fluid-filled type active vibration damping devices which are adapted to apply oscillation force of an electromagnetic actuator to the fluid chamber thereby actively reducing vibrations. Such fluid-filled type active vibration damping devices have a structure in which an oscillation member partially defining a wall of the fluid chamber and a movable member adapted to be oscillated in one axial direction through energization are linked with each other by a shaft member, and adapted to exhibit canceling vibration damping effect by transmitting oscillation force of the movable member to the oscillation member via the shaft member. U.S. Pat. No. 6,422,546 discloses one example of such a fluid-filled type active vibration damping device.

In view of facility in fabrication of the fluid-filled type active vibration damping devices or the like, it is general to separately manufacture a vibration damping device main unit having a fluid chamber with a non-compressible fluid filled therein and an electromagnetic actuator adapted to generate oscillation force through energization from a power supply unit and assemble them together later.

However, in the above-described structure in which the vibration damping device main unit and the electromagnetic actuator are assembled after manufacture thereof, due to component dimensional errors or the like, the vibration damping device main unit and the electromagnetic actuator may suffer from the problems of axial deviation or tilt relative to each other during assembly. In association with the tilt or axial deviation of the vibration damping device main unit and the electromagnetic actuator relative to each other, the shaft member may be subjected to tilt or axial deviation with respect to the prescribed position. This may cause tilt or axial deviation of the movable member connected to the shaft member with respect to the stator, thereby posing a risk of abutment between the movable member and the stator which should be positioned spaced apart from each other with a tiny gap. As a result, in the electromagnetic actuator, there was a possibility of malfunction such as operation failure due to seizing, deterioration of durability due to rubbing, and deterioration of vibration damping ability caused by failure of the intended oscillation force to be exhibited due to frictional resistance during sliding contact, or the like.

In U.S. Pat. No. 6,422,546, the shaft member for transmitting oscillation force of the movable member to the fluid chamber is inserted loosely through a tubular movable member while the shaft member and the movable member are elastically connected with each other by a saucer spring clasped therebetween. With the aim of avoiding abutment of the movable member against the stator, in U.S. Pat. No. 6,422,546, displacement of the shaft member caused by relative tilt or axial deviation between the vibration damping device main unit and the electromagnetic actuator is inhibited from acting directly on the movable member. However, with the structure disclosed in U.S. Pat. No. 6,422,546, if the saucer spring has a high level of allowable deformation, the oscillation force will be absorbed by the deformation of the saucer spring on the transmission path from the movable member to the shaft member, making it difficult to realize intended vibration damping ability. On the other hand, if the saucer spring has a low level of allowable deformation, there is a risk that tilt or axial deviation between the shaft member and the movable member will not sufficiently be absorbed, causing positioning deviation of the movable member relative to the stator. Therefore, it was still difficult to achieve both enhanced vibration damping ability by means of efficient transmission of the oscillation force with high accuracy, and excellent durability.

### SUMMARY OF THE INVENTION

With the foregoing in view, it is an object of this invention to provide a fluid-filled type active vibration damping device of novel construction being capable of preventing tilt or axial deviation of the movable member relative to the stator due to assembly error of the vibration damping device main unit and the electromagnetic actuator or the like, and realizing desired vibration damping ability owing to efficient transmission of oscillation force, as well as a method for manufacturing the same.

The above objects of this invention may be attained according to the following modes of the invention, wherein elements described hereinbelow may be adopted in any possible optional combination.

A first mode of the present invention provides a fluid-filled type active vibration damping device including: a vibration damping device main unit having a first mounting member and a second mounting member connected with each other by a main rubber elastic body, and a fluid chamber whose wall is partially defined by the main rubber elastic body and filled with a non-compressible fluid; an oscillation member defining another portion of the wall of the fluid chamber; an actuator disposed on an opposite side of the fluid chamber with the oscillation member being interposed therebetween and attached to the vibration damping device main unit, while being adapted to apply actuating force to the oscillation member and bring about excited displacement of the oscillation member, the actuator being constituted by an electromagnetic actuator having a stator that includes a coil fixed to the second mounting member while having a movable member linearly displaceable relative to the stator when the coil is energized; a shaft member provided for connecting the movable member and the oscillation member with each other; a connecting portion provided for attaching the shaft member to the movable member while permitting the shaft member to tilt as well as to undergo displacement in an axis-perpendicular direction with respect to the movable member; and a displacement preventing portion provided for fastening the movable member and the shaft member to each other by preventing tilt as well as displacement in the axis-perpendicular direction due to the connecting portion.

According to the first mode, the shaft member and the movable member are connected by the connecting portion in the state where swinging and displacement in the axis-perpendicular direction relative to each other are permitted. This arrangement permits tilt as well as axial deviation of the center axis of the shaft member and the center axis of the movable member relative to each other due to assembly error of the vibration damping device main unit and the electromagnetic actuator, component dimensional error, or the like. Therefore, the movable member will be prevented from undergoing tilt as well as axial deviation relative to the stator due to force in the prizing direction or in the in the axis-perpendicular direction exerted by the shaft member. This enables the electromagnetic actuator to avoid troubles such as operation failure, deterioration of oscillating ability, deterioration of durability or the like caused by seizing or sliding contact between the movable member and the stator. In addition, it is possible to avoid defective connection between the shaft member and the movable member due to tilt or axial deviation relative to each other, thereby reducing occurrence of defective products during assembly of the vibration damping device main unit and the electromagnetic actuator.

Moreover, after connection by the connecting portion, the shaft member and the movable member are secured by the displacement preventing portion so that neither swinging nor displacement is possible. Accordingly, it is possible to prevent deterioration of vibration damping ability due to reduction of oscillation force on the transmission path from the movable member to the oscillation member. Specifically, if the shaft member is allowed to undergo swinging and displacement with respect to the movable member, axial oscillation force of the movable member, during transmission to the shaft member, may be dispersed to the swinging direction or to the axis-perpendicular direction. This poses a risk of deterioration of transmission efficiency of the axial oscillation force. In this respect, by means of the shaft member and the movable member being secured after connection, the axial oscillation force of the movable member will be transmitted to the oscillation member with little loss, applying desired oscillation force to the fluid chamber. As a result, active or canceling vibration damping effect with respect to the input vibration can be effectively exhibited, achieving desired excellent vibration damping ability.

A second mode of the present invention provides a fluid-filled type active vibration damping device according to the first mode, wherein the connecting portion comprises a ball joint having a bearing inner ring and a bearing outer ring which are allowed to experience relative swinging; the bearing inner ring of the ball joint is provided to the shaft member while the bearing outer ring is inserted into the movable member of tubular shape and supported so as to be capable of relative displacement in the axis-perpendicular direction; the electromagnetic actuator is attached to the vibration damping device main unit; and the bearing inner ring and the bearing outer ring are fixed to each other by the displacement preventing portion while the bearing outer ring is fixed to the movable member.

According to the second mode, by employing a ball joint as the connecting portion, the connecting portion that permits swinging of the shaft member and the movable member can be specifically and readily realized utilizing a known structure. In addition, since the bearing outer ring situated to the movable member side of the ball joint is supported in a displaceable manner relative to the movable member in the axis-perpendicular direction, relative displacement of the shaft member and the movable member in the axis-perpendicular direction is also readily permitted by virtue of the connecting portion.

A third mode of the present invention provides a fluid-filled type active vibration damping device according to the second mode, wherein the bearing inner ring includes a bulging portion whose outside peripheral face is of spherical shape while the bearing outer ring comprises a first ring and a second ring; the first ring and the second ring are fitted externally onto the shaft member from axially opposite sides of the bulging portion; and the first ring and the second ring are fixed to the movable member by being tightened from the axially opposite sides of the bulging portion by the displacement preventing portion so as to become closer to each other.

According to the third mode, by means of the first ring and the second ring being tightened from the axially opposite sides of the bulging portion so as to become closer to each other, the displacement preventing portion will be realized through an extremely simple structure utilizing frictional resistance acting among the first and second rings, the shaft member, and the movable member. For instance, by threading or press fitting of the first ring and the second ring themselves or other member into the movable member in the axial direction, it is possible to tighten the first ring and the second ring so as to become axially closer to each other.

A fourth mode of the present invention provides a method of manufacturing a fluid-filled type active vibration damping device according to any one of the first to third modes, the method comprising: a first preparation step in which the first mounting member and the second mounting member are connected with each other by the main rubber elastic body to form the vibration damping device main unit; a second preparation step in which the stator and the movable member are assembled to form the electromagnetic actuator; an attachment step in which the electromagnetic actuator is attached to the vibration damping device main unit; a connection step in which, after the attachment step, the shaft member and the movable member are assembled by the connecting portion while being permitted to tilt as well as to displace in the axis-perpendicular direction relative to each other; a displacement prevention step in which, after the connection step, the shaft member and the movable member are fastened to each other by the displacement preventing portion so as to be prevented from undergoing displacement relative to each other.

According to the method as shown in the fourth mode, it is possible to specifically manufacture the fluid-filled type active vibration damping device of the present invention by the connection step that absorbs tilt as well as axial deviation of the shaft member and the movable member relative to each other, and by the displacement prevention step posterior to the connection step that secures the shaft member and the movable member.

According to the present invention, the shaft member and the movable member are connected by the connecting portion in the state where swinging and displacement in the direction orthogonal to the oscillation direction are permitted. With this arrangement, relative tilt or deviation between the center axis of the shaft member and the center axis of the movable member will be absorbed by the connecting portion of the shaft member and the movable member, thereby preventing defective connection of the shaft member and the movable member, as well as operation failure, deterioration of durability or the like due to contact between the movable member and the stator. Furthermore, by means of the shaft member and the movable member being secured to each other by the displacement preventing portion after connection by the connecting portion, efficient transmission of oscillation force can be realized.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a fluid-filled type active vibration damping device in the form of an automotive engine mount, which is constructed according to a first embodiment of the invention;

FIGS. 2A-2D are enlarged views in axial or vertical cross section each showing a principle part of the engine mount; FIG. 2A shows a state where neither axial tilt nor axial deviation occurs; FIG. 2B shows a state where only axial tilt occurs;

FIG. 2C shows a state where only axial deviation occurs; and FIG. 2D shows a state where both axial tilt and axial deviation occur;

FIG. 3 is an elevational view in axial or vertical cross section of an automotive engine mount according to a second embodiment of the present invention; and

FIG. 4 is an enlarged view in axial or vertical cross section showing a principle part of an automotive engine mount according to another embodiment of the present invention.

### DETAILED DESCRIPTION OF PREFERRED EMBODIMENTS

Embodiments of the present invention will be described below with reference to the accompanying drawings.

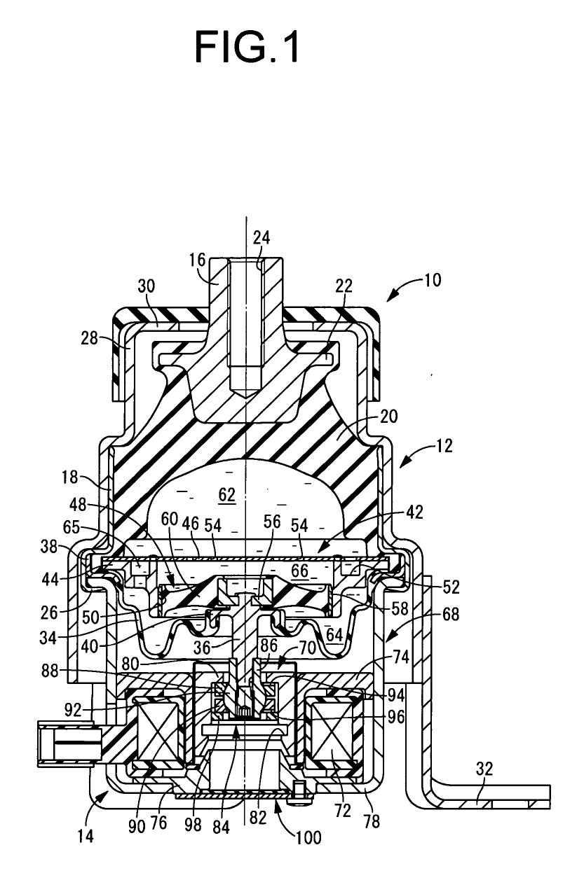

Referring first to FIG. 1, there is depicted an automotive engine mount 10 as a first embodiment of the fluid-filled type active vibration damping device of construction according to the present invention. The engine mount 10 has a construction in which an electromagnetic actuator 14 is attached to a mount body 12 serving as a vibration damping device main unit. The mount body 12 includes a first mounting member 16 of metal and a second mounting member 18 of metal, which are connected with each other by means of a main rubber elastic body 20. In the description hereinbelow, unless indicated otherwise, vertical direction refers to the vertical direction in FIG. 1, which is also the mount axial direction.

To describe in greater detail, the first mounting member 16 has a generally circular post shape overall. At the axial medial portion of the first mounting member 16, there is integrally formed a flange portion 22 of annular plate shape extending in the outer peripheral side. The first mounting member 16 includes a mounting hole 24 that extends along the center axis and opens onto the upper face, with a thread having been cut into the inside peripheral face of the mounting hole 24. The first mounting member 16 is designed to be secured to a power unit (not shown) with a bolt which is threaded through the mounting hole 24.

The second mounting member 18 has thin-walled, large-diameter, generally stepped circular cylinder shape, with the upper portion of the step made smaller in diameter than the lower portion of the step. At the lower end of the second mounting member 18, there is integrally formed a tubular swaging piece 26 so as to project downwardly. A bracket 28 is mounted onto the second mounting member 18. The bracket 28 has large-diameter, generally circular cylinder shape and at the upper end thereof there is integrally formed an internal flange-shaped stopper portion 30 while to the outside peripheral face of the lower end thereof there are fixed a plurality of fixation legs 32 projecting downwardly. The second mounting member 18 is designed to be mounted onto a vehicle body (not shown) via the bracket 28 by securing the fixation legs 32 to the vehicle body with bolts.

The first mounting member 16 is disposed coaxially with the second mounting member 18 and spaced apart axially thereabove, with the first mounting member 16 and the second mounting member 18 elastically connected by the main rubber elastic body 20. The main rubber elastic body 20 has large-diameter, generally frustoconical shape and at the small-diameter end thereof the first mounting member 16 is bonded by vulcanization with its lower portion embedded therein. A small-diameter section of the second mounting member 18 is superposed on and bonded by vulcanization to the outside peripheral face of the large-diameter end of the main rubber elastic body 20. In the present embodiment, the main rubber elastic body 20 takes the form of an integrally vulcanization molded component incorporating the first mounting member 16 and the second mounting member 18.

A diaphragm 34 is attached to the second mounting member 18. The diaphragm 34 is a rubber film of thin, large-diameter, approximately annular disk shape having ample slack in the axial direction. A shaft member 36 is bonded by vulcanization to the inner peripheral edge of the diaphragm 34 while a fastener fitting 38 is bonded by vulcanization to the outer peripheral edge thereof.

The shaft member 36 has a rod shape extending in a straight line. A projection is integrally formed at the upper end of the shaft member 36 while a flange-shaped anchor portion 40 is integrally formed with the axial medial portion thereof. The shaft member 36 is disposed so as to pass through the diametrical center section of the diaphragm 34 by the anchor portion 40 bonded by vulcanization to the inner peripheral edge of the diaphragm 34.

The fastener fitting 38 is an annular member with a generally “L” shaped cross section, and at its base wall part the outer peripheral edge of the diaphragm 34 is bonded by vulcanization. With the fastener fitting 38 detained by caulking against the swaging piece 26 of the second mounting member 18, the diaphragm 34 is attached so as to close off the lower opening of the second mounting member 18.

In this way, with the diaphragm 34 attached to the integrally vulcanization molded component of the main rubber elastic body 20, the axial upper opening of the second mounting member 18 is closed off by the main rubber elastic body 20 while the axial lower opening of the second mounting member 18 is closed off by the diaphragm 34. With this arrangement, between the axially opposing faces of the main rubber elastic body 20 and the diaphragm 34 in the inner peripheral side of the second mounting member 18, there is formed a fluid-filled zone that is isolated from the outside and is filled with a non-compressible fluid. While no particular limitation is imposed as to the non-compressible fluid filling the fluid-filled zone, favorable examples are water, an alkylene glycol, a polyalkylene glycol, silicone oil, a mixture of these, or the like. In terms of advantageously achieving vibration damping effect based on flow action of the fluid, discussed later, it is preferable to employ low-viscosity fluids having viscosity of 0.1 Pa·s or lower.

A partition member 42 is disposed within the fluid-filled zone. The partition member 42 is of thick, generally circular disk shape overall and includes a partition member body 44, a cover fitting 46, and an oscillation plate 48.

The partition member body 44 has a thick, generally circular disk shape with a center hole 50 that perforates its diametrical center section in the axial direction. In the outer circumferential portion of the partition member body 44 there is formed a circumferential groove 52 that extends a prescribed length in the circumferential direction and opens onto the upper face of the partition member body 44.

The cover fitting 46 is of thin, generally disk shape and has an outside diameter dimension approximately equal to that of the partition member body 44. There are formed a plurality of through-holes 54 having small-diameter circular shape so as to pierce the diametrical medial section of the cover fitting 46 in the thickness direction. The cover fitting 46 is superposed against and fastened to the partition member body 44 from above. With this arrangement, the opening of the circumferential groove 52 formed in the partition member body 44 is covered with the cover fitting 46 so as to provide a tunnel-like passage that extends in the circumferential direction.

The oscillation plate 48 has a structure in which an oscillation member 56 and a mating attachment fitting 58 are connected by a supporting rubber elastic body 60. The oscillation member 56 is a rigid member having a small-diameter, generally round tubular shape with a bottom. There is formed a small-diameter locking hole so as to pass through the bottom wall of the oscillation member 56 in the axial direction. The mating attachment fitting 58 is of thin, large-diameter, generally circular cylinder shape with the outside diameter dimension slightly greater than the inside diameter dimension of the center hole 50 formed in the partition member body 44. The supporting rubber elastic body 60 is a rubber elastic body having a generally annular disk shape and becomes progressively thicker towards the inner peripheral side in its entirety. The inside peripheral face of the supporting rubber elastic body 60 is juxtaposed against and bonded by vulcanization to the outside peripheral face of the peripheral wall of the oscillation member 56 while the outside peripheral face of the supporting rubber elastic body 60 is juxtaposed against and bonded by vulcanization to the inside peripheral face of the mating attachment fitting 58 thereby forming the oscillation plate 48. Namely, the oscillation plate 48 takes the form of an integrally vulcanization molded component of the supporting rubber elastic body 60 incorporating the oscillation member 56 and the mating attachment fitting 58.

With the mating attachment fitting 58 press-fitted into the center hole 50 of the partition member body 44, the oscillation plate 48 is disposed within the center hole 50 so as to extend in the axis-perpendicular direction. Accordingly, the center hole 50 is blocked by the oscillation plate 48. The oscillation plate 48 is positioned below the cover fitting 46 with a prescribed separation distance therebetween so that a space is formed between axially opposed faces of the cover fitting 46 and the oscillation plate 48.

The partition member 42 of the above construction is positioned within the fluid-filled zone so as to extend in the axis-perpendicular direction and fastened at its outer peripheral edge by the swaging piece 26 of the second mounting member 18. With this arrangement, the partition member 42 is supported by the second mounting member 18 and disposed so as to divide the fluid-filled zone into two parts in the vertical direction. Accordingly, to the axially upper side of the partition member 42 there is formed a pressure-receiving chamber 62 whose wall is partially defined by the main rubber elastic body 20 and that experiences internal pressure fluctuations during vibration input. Meanwhile, to the axially lower side of the partition member 42 there is formed an equilibrium chamber 64 whose wall is partially defined by the diaphragm 34 and which readily allows change in volume. The pressure-receiving chamber 62 and the equilibrium chamber 64 are filled with a non-compressible fluid.

One circumferential end of the circumferential groove 52 formed in the outer circumferential portion of the partition member body 44 communicates with the pressure-receiving chamber 62 while the other end thereof communicates with the equilibrium chamber 64, thereby defining an orifice passage 65 that connects the pressure-receiving chamber 62 and the equilibrium chamber 64 to each other. By establishing the ratio (A/L) of passage cross sectional area (A) to passage length (L), the orifice passage 65 is tuned to a low frequency corresponding to engine shake.

Moreover, a space formed between axially opposed faces of the cover fitting 46 and the oscillation plate 48 is also filled with a non-compressible fluid. An excitation chamber 66 whose wall is partially defined by the oscillation plate 48 is provided utilizing the space. The excitation chamber 66 communicates with the pressure-receiving chamber 62 through the plurality of through-holes 54 that have been formed perforating the cover fitting 46 so that fluid pressure of the excitation chamber 66 will exert on the pressure-receiving chamber 62. A fluid chamber according to the present embodiment is defined by the pressure-receiving chamber 62 and the excitation chamber 66 communicating with each other.

The projection formed at the upper end of the shaft member 36 is inserted through and detained by caulking against the locking hole of the oscillation member 56 which constitutes the oscillation plate 48. With this arrangement, the shaft member 36 is positioned passing through the diaphragm 34 so that oscillation force exerted on the shaft member 36 from a movable member 70 (described later) will be transmitted to the oscillation member 56.

To the mount body 12 constructed in the above manner the electromagnetic actuator 14 is attached. The electromagnetic actuator 14 is disposed below the mount body 12, and includes a stator 68 securely supported by the second mounting member 18, and a movable member 70 adapted to be forced to displace relative to the stator 68 in the axial direction.

The stator 68 includes a coil 72 wrapped around a bobbin formed of nonmagnetic material. The coil 72 is adapted to be energized from the outside through an energizing terminal fixed to the bobbin so that a magnetic field will be generated through energization of the coil 72. The coil 72 includes an upper yoke fitting 74 and a lower yoke fitting 76 attached thereto. The upper and lower yoke fittings 74, 76 are both formed of ferromagnetic material. The upper yoke fitting 74 is juxtaposed against the upper face and the inside peripheral face of the coil 72 while the lower yoke fitting 76 is juxtaposed against the lower face of the coil 72. The coil 72 with the upper and lower yoke fittings 74, 76 attached thereto is supported by the second mounting member 18 via a housing 78. The housing 78 has a generally round tubular shape with a bottom and supports the coil 72 as well as the upper and lower yoke fittings 74, 76 in its lower part. Meanwhile, the housing 78 is connected to the second mounting member 18 with a flange integrally formed to its upper end portion secured by the swaging piece 26. Furthermore, the housing 78 is formed of ferromagnetic material and forms a magnetic path around the coil 72 in cooperation with the upper and lower yoke fittings 74, 76. When the coil 72 is energized, a magnetic pole will form at each of the lower end of the inner peripheral portion of the tubular upper yoke fitting 74 and the upper end of the inner peripheral portion of the annular lower yoke fitting 76. An annular spacer formed of an insulator is interposed between axially opposite inner peripheral portion of the upper yoke fitting 74 and the outer peripheral portion of the lower yoke fitting 76.

The movable member 70 has a generally round tubular shape that extends straightly in the axial direction and is made of ferromagnetic material. At the upper end edge of the movable member 70 there is integrally formed an internal flange-shaped mating projection 80 while the lower end edge of the movable member 70 is such that the inside peripheral face has tapered contours of gradually flaring diameter towards the bottom and becomes progressively thinner towards the bottom. Moreover, in the axial medial portion of the movable member 70, there is formed a mating groove 82 that opens onto the inside peripheral face thereof and extends about the entire circumference. The movable member 70 has the outside diameter dimension slightly smaller than the inside diameter dimension of the upper yoke fitting 74.

With this arrangement, the movable member 70 is inserted into the inner peripheral side of the upper yoke fitting 74 with a tiny gap therebetween. Also, the movable member 70 is positioned axially above and spaced apart from the lower end of the inner peripheral portion of the upper yoke fitting 74 as well as the upper end of the inner peripheral portion of the lower yoke fitting 76. When the coil 72 is energized, magnetic poles will form on the upper and lower yoke fittings 74, 76 so that attracting force exerts between the stator 68 and the movable member 70 in the axial direction. Accordingly, the movable member 70 will be actuated to undergo displacement axially downwardly with respect to the stator 68. In the present embodiment, by controlling ON/OFF of energizing of the coil 72, oscillation force will exhibit according to the frequency of vibration which can be a problem by virtue of elasticity of the supporting rubber elastic body 60. It may alternatively be possible to employ an electromagnetic actuator or the like such that by controlling the direction of energization of the coil 72 with an AC power supply, attracting force and repellent force will alternately exert on the movable member 70 so as to exhibit an intended oscillation force.

The electromagnetic actuator 14 of the above construction is disposed to axially lower side of the mount body 12 and attached to the mount body 12. Specifically, with the flange integrally formed to the upper end portion of the housing 78 of the electromagnetic actuator 14 secured by the swaging piece 26 of the second mounting member 18, the mount body 12 and the electromagnetic actuator 14 are connected with each other.

Furthermore, the shaft member 36 of the mount body 12 and the movable member 70 of the electromagnetic actuator 14 is connected with each other via a ball joint 84 serving as a connecting portion. The ball joint 84 includes a bearing inner ring 86 attached to the shaft member 36 side, and a first ring 88 and a second ring 90 serving as bearing outer rings and attached to the movable member 70 side.

The bearing inner ring 86 is of generally circular cylinder shape and has a nut structure with a thread having been cut along the entire length of the inside peripheral face in the axial direction. To the lower portion of the bearing inner ring 86 there is provided a bulging portion 92 larger in diameter in comparison with the upper portion thereof. The outside peripheral face of the bulging portion 92 is of ball form with a curving surface.

The first and second rings 88, 90 are both annular fittings. The outside diameter dimension of the first and second rings 88, 90 is smaller than the inside diameter dimension of the center hole of the movable member 70 but is larger than the inside diameter dimension of the center hole of the movable member 70 at the portion where the mating projection 80 is formed. The lower inside peripheral face of the first ring 88 is a spherical contact face that corresponds to the upper outside peripheral face of the bulging portion 92 of the bearing inner ring 86. Meanwhile, the upper inside peripheral face of the second ring 90 is a spherical contact face that corresponds to the lower outside peripheral face of the bulging portion 92 of the bearing inner ring 86. Moreover, the first ring 88 includes first slots 94 that open onto its upper face at several locations along the circumference and extend along the entire diametrical length thereof. Furthermore, the second ring 90 includes second slots 96 that open onto its lower face at several locations along the circumference and extend along the entire diametrical length thereof.

The first and second rings 88, 90 are fitted externally onto the bearing inner ring 86. The contact face of the first ring 88 is superposed against the upper outside peripheral face of the bulging portion 92 of the bearing inner ring 86 while the contact face of the second ring 90 is superposed against the lower outside peripheral face of the bulging portion 92. Accordingly, the bulging portion 92 is retained clasped between the first and second rings 88, 90 in the axial direction. With this arrangement, the bearing inner ring 86 is retained so as to be allowed to swing, whereby the bearing inner ring 86, the first and second rings 88, 90 define the ball joint 84.

The ball joint 84 constructed as above is interposed between the shaft member 36 and the movable member 70. Specifically, the bearing inner ring 86 is secured to the shaft member 36 by being screw-fastened to the bolt part provided to the lower end portion of the shaft member 36 and by means of a lock bolt being threaded thereinto from below. Meanwhile, the first and second rings 88, 90 are inserted into the inner peripheral side of the movable member 70 and retained spaced away from the movable member 70 by a prescribed distance in the diametrical direction. With the bearing inner ring 86 attached to the shaft member 36 and with the first and second rings 88, 90 attached to the movable member 70, the shaft member 36 and the movable member 70 are connected via the ball joint 84 and are permitted relative tilt. During attachment of the bearing inner ring 86 to the shaft member 36, by tuning screw feed, it is possible to adjust the separation distance (magnetic gap) between the movable member 70 and the stator 68 in the axial direction and to tune the oscillation force. It would also be acceptable that the bulging portion 92 is integrally formed with the lower end portion of the shaft member 36 whereby the bearing inner ring of the ball joint is defined by the lower end portion of the shaft member.

Between the inside peripheral face of the movable member 70 and the outside peripheral faces of the first and second rings 88, 90, there is formed a prescribed gap in the axis-perpendicular direction. In addition, the first ring 88 is slidably superposed against the mating projection 80 of the movable member 70 from axially below. With this arrangement, the first and second rings 88, 90 are permitted to experience displacement relative to the movable member 70 in the diametrical direction. Axial deviation between the shaft member 36 and the movable member 70 is thereby allowed through displacement of the first and second rings 88, 90 in the axis-perpendicular direction.

By so doing, with the electromagnetic actuator 14 attached to the mount body 12, even in the case where the center axis of the shaft member 36 and the center axis of the movable member 70 experience tilt or axial deviation relative to each other, the deviation can be absorbed by the connecting portion of these shaft member 36 and the movable member 70.

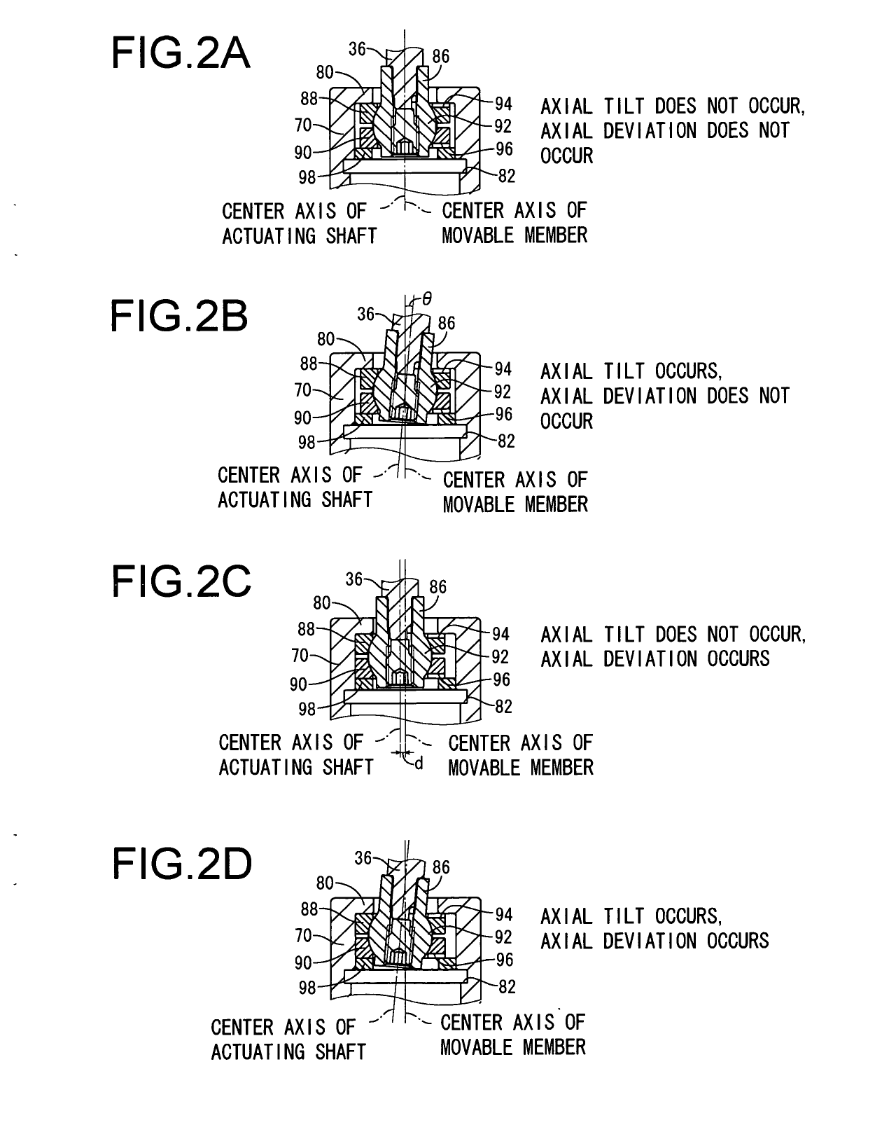

Described more specifically, with the electromagnetic actuator 14 attached to the mount body 12, if the center axis of the shaft member 36 and the center axis of the movable member 70 is aligned with each other, as shown in FIG. 2A, the bearing inner ring 86, the first and second rings 88, 90 are positioned so that their center axes are aligned with one another. Consequently, the shaft member 36 and the movable member 70 are coaxially connected.

If the center axis of the shaft member 36 and the center axis of the movable member 70 tilt by the angle: θ respective to each other, as shown in FIG. 2B, the bearing inner ring 86 swings so as to tilt by the angle: θ with respect to the first and second rings 88, 90. Accordingly, even in the state where the shaft member 36 and the movable member 70 tilt relative to each other, the shaft member 36 and the movable member 70 are connected with each other without problems. Besides, force in the prizing direction acts on the movable member 70, thereby preventing tilt of the movable member 70 with respect to the stator 68.

In the case where the center axis of the shaft member 36 and the center axis of the movable member 70 are parallel (do not tilt) with respect to each other and at the same time deviate by the distance: d from each other in the axis-perpendicular direction, as shown in FIG. 2C, the ball joint 84 moves by the distance: d respective to the movable member 70 in the axis-perpendicular direction and is positioned coaxially with the shaft member 36. Consequently, even in the state where the shaft member 36 and the movable member 70 experience axial deviation relative to each other, the shaft member 36 and the movable member 70 are connected with each other without problems. Besides, force in the axis-perpendicular direction acts on the movable member 70, thereby preventing displacement of the movable member 70 relative to the stator 68 in the axis-perpendicular direction.

As shown in FIG. 2D, if the center axis of the shaft member 36 and the center axis of the movable member 70 tilt by the angle: θ relative to each other and at the same time deviate in the axis-perpendicular direction, the shaft member 36 and the movable member 70 are connected in a state of FIG. 2B in combination with FIG. 2C. Specifically, the bearing inner ring 86 swings so as to tilt by the angle: θ relative to the first and second rings 88, 90 while the entire ball joint 84 undergoes displacement with respect to the movable member 70 in the axis-perpendicular direction. By so doing, the shaft member 36 and the movable member 70 are stably connected while tilt or displacement of the movable member 70 with respect to the stator 68 is prevented.

The first and second rings 88, 90 are held positioned with respect to the movable member 70 by a fastening ring 98 serving as a fastening member. The fastening ring 98 is an annular fitting that has an outside diameter dimension slightly larger than the inside diameter dimension of the movable member 70. After the first and second rings 88, 90 are placed in the inner peripheral side of the movable member 70, the fastening ring 98 is secured press-fit into the movable member 70 from below against these first and second rings 88, 90. Accordingly, the first and second rings 88, 90 are held in the inner peripheral side of the movable member 70.

By means of the fastening ring 98 being press-fitted into the movable member 70, the bearing inner ring 86 and the first, second rings 88, 90 are subjected to axially upward force. With this arrangement, the first and second rings 88, 90 are tightened from the axially opposite sides of the bulging portion 92 so as to become closer to each other, making contact pressure higher between the outside peripheral face of the bulging portion 92 of the bearing inner ring 86 and each contact face of the first, second rings 88, 90. As a result, frictional resistance acting between the bearing inner ring 86 and the first, second rings 88, 90 increases, so that these bearing inner ring 86 and the first, second rings 88, 90 are placed in a state of substantially rigid connection. Therefore, relative swinging of the shaft member 36 and the movable member 70 will be limited. Meanwhile, contact pressure becomes higher between the upper face of the first ring 88 and the mating projection 80 of the movable member 70. As a result, frictional resistance acting between the first ring 88 and the movable member 70 increases, so that these first ring 88 and the movable member 70 are placed in a state of substantially rigid connection. Therefore, relative displacement of the shaft member 36 and the movable member 70 in the axis-perpendicular direction will be limited. That is, by means of the fastening ring 98 being secured press-fit into the movable member 70, the shaft member 36 and the movable member 70 are prevented from undergoing swinging and displacement relative to each other. Thus, the shaft member 36 and the movable member 70 are fixed to each other so as to be integrally connected. As will be apparent from the above description, the fastening ring 98 serves as a displacement preventing portion. No particular limitation is imposed as to the way for securing the fastening ring 98 to the movable member 70, and for instance the fastening ring 98 may be threaded into the movable member 70 and positioned.

When the coil 72 is not being energized, the shaft member 36, the ball joint 84, and the movable member 70 are held in the initial position by elastic force of the supporting rubber elastic body 60 such that the axial distance (magnetic gap) between the movable member 70 and the stator 68 is set to the prescribed dimension. Upon energization of the coil 72, the movable member 70 will be attracted and displaced toward the stator 68 side (axially lower side). Then, when supply of current to the coil 72 is halted, the movable member 70 will be returned to the initial position that is spaced apart from the stator 68 with a prescribed gap, based on elastic recovery force of the supporting rubber elastic body 60.

After fixation of the shaft member 36 and the movable member 70, the center hole of the lower yoke fitting 76 is covered with a base plate member 100. The base plate member 100 is furnished with a support portion formed of a circular metal plate and a rubber sheet affixed onto the upper face of the diametrically center section of the support portion. The base plate member 100 is juxtaposed against the lower face of the lower yoke fitting 76 and secured thereto with the support portion being screw-fastened at the several locations along the circumference. By so doing, the lower opening of the center hole of the lower yoke fitting 76 is closed off in a sealed state, preventing entry of debris such as a particulate from the outside.

Moreover, the plurality of the first slots 94 are formed onto the first ring 88 while the plurality of the second slots 96 are formed onto the second ring 90. In addition, both the inside diameter dimension of the movable member 70 at the section where the mating projection 80 is formed and the inside diameter dimension of the fastening ring 98 are greater than the inside diameter dimensions of the first and second rings 88, 90. With this arrangement, after fixation of the shaft member 36 and the movable member 70, two spaces situated to the upper and lower sides of the movable member 70 communicate with each other via the first, second slots 94, 96 and the spacing of the outer peripheral side of the first, second rings 88, 90. Accordingly, even after sealing off the center hole of the lower yoke fitting 76 with the base plate member 100, excited displacement of the movable member 70 is hardly or not affected by an air spring. Therefore, desired oscillation force will be exhibited with sufficient accuracy.

Next, there will be described one example of a manufacturing method of the engine mount 10 of construction according to the present embodiment.

Initially, an integrally vulcanization molded component of the main rubber elastic body 20 incorporating the first mounting member 16 and the second mounting member 18 is formed. The partition member 42 and the diaphragm 34 are then attached to the integrally vulcanization molded component so as to form the mount body 12. This completes the first preparation step.

Subsequently, the stator 68 is attached to the housing 78, and the movable member 70 is positioned inserted into the borehole of the stator 68 having a tubular shape, thereby forming the electromagnetic actuator 14. This completes the second preparation step.

Then, mount body 12 and the electromagnetic actuator 14 are positioned coaxially in the vertical direction and connected to each other with the housing 78 caulked by the second mounting member 18. This completes the attachment step. During connection of the mount body 12 and the electromagnetic actuator 14, in preferred practice the lower end portion of the shaft member 36 is movably inserted into the movable member 70. After the caulking, the bracket 28 prepared in advance is mounted onto the second mounting member 18.

When the aforementioned attachment step is completed, the shaft member 36 and the movable member 70 are connected in the state where swinging and displacement in the axis-perpendicular direction relative to each other are permitted. Specifically, first, the first ring 88 is inserted into the movable member 70 and slidably superposed against the mating projection 80. Second, the bearing inner ring 86 is inserted into the movable member 70 and the first ring 88, and screw-fastened to the lower end portion of the shaft member 36. Last, the second ring 90 is fitted externally onto the bearing inner ring 86 and positioned to the inner peripheral side of the movable member 70. This completes the connection step.

Afterward, by means of the fastening ring 98 being press-fitted into the movable member 70, axially upward force acts on the second ring 90, thereby preventing swinging and displacement of the shaft member 36 and the movable member 70. This completes the displacement prevention step. During press fitting of the fastening ring 98, it is possible to obtain reaction force with respect to the press-fitting force by hooking a jig onto the mating groove 82 in order to support the movable member 70. When the displacement prevention step is finished, the base plate member 100 is attached to the lower yoke fitting 76, thereby completing manufacture of the engine mount 10.

With the engine mount 10 of this construction installed onto the vehicle, when a low-frequency, large-amplitude vibration corresponding to engine shake is input, relative pressure fluctuations are induced between the pressure-receiving chamber 62 and the equilibrium chamber 64. Consequently, fluid flow will take place between the pressure-receiving chamber 62 and the equilibrium chamber 64 through the orifice passage 65 tuned to low frequency. Accordingly, vibration damping effect (high attenuating or damping action) will exhibit on the basis of the flow action of the fluid.

On the other hand, when a midrange- to high-frequency, small-amplitude vibration corresponding to idling vibration or driving rumble is input, energization of the coil 72 by the power supply unit starts on the basis of a signal or the like from the ECU, so that the movable member 70 undergoes excited displacement in the axial direction with respect to the stator 68 at the prescribed frequency. Then, transmission of the oscillation force from the movable member 70 to the oscillation member 56 via the shaft member 36 applies oscillation corresponding to the input vibration to the excitation chamber 66, exhibiting canceling vibration damping effect with respect to the input vibration.

Moreover, in the engine mount 10 constructed as above, even if the mount body 12 and the electromagnetic actuator 14 undergo tilt or axial deviation relative to each other because of component dimensional error or the like, it is possible to avoid defective connection between the oscillation member 56 and the movable member 70 due to the shaft member 36. Besides, stable transmission of the oscillation force can be realized.

Specifically, with the mount body 12 and the electromagnetic actuator 14 connected with each other, the engine mount 10 permits the shaft member 36 to swing as well as to displace by parallel motion in the axis-perpendicular direction with respect to the movable member 70. With this arrangement, tilt or axial deviation of the mount body 12 and the electromagnetic actuator 14 relative to each other will be absorbed by the connecting portion between the shaft member 36 and the movable member 70. Therefore, even if the mount body 12 and the electromagnetic actuator 14 undergo tilt or axial deviation relative to each other because of dimensional error, assembly error or the like, difficulty in connecting the shaft member 36 and the movable member 70 or unstable connected state between them can be avoided. Additionally, occurrence of tilt or axial deviation between the movable member 70 and the stator 68 relative to each other caused by tilt or axial deviation between the shaft member 36 and the movable member 70 is prevented. Thus, it is possible to avoid seizing or sliding contact between the movable member 70 and the stator 68, thereby achieving stable operation and improvement of durability of the electromagnetic actuator 14.

Furthermore, the movable member 70 and the shaft member 36 are connected and then integrally fastened by the fastening ring 98 in a condition preventing relative swinging and displacement in the axis-perpendicular direction. Accordingly, the excitation chamber 66 will be prevented from experiencing diminished oscillation force due to relative displacement or tilt between the shaft member 36 and the movable member 70, whereby canceling vibration damping effect with respect to the midrange- to high-frequency vibration can be effectively obtained.

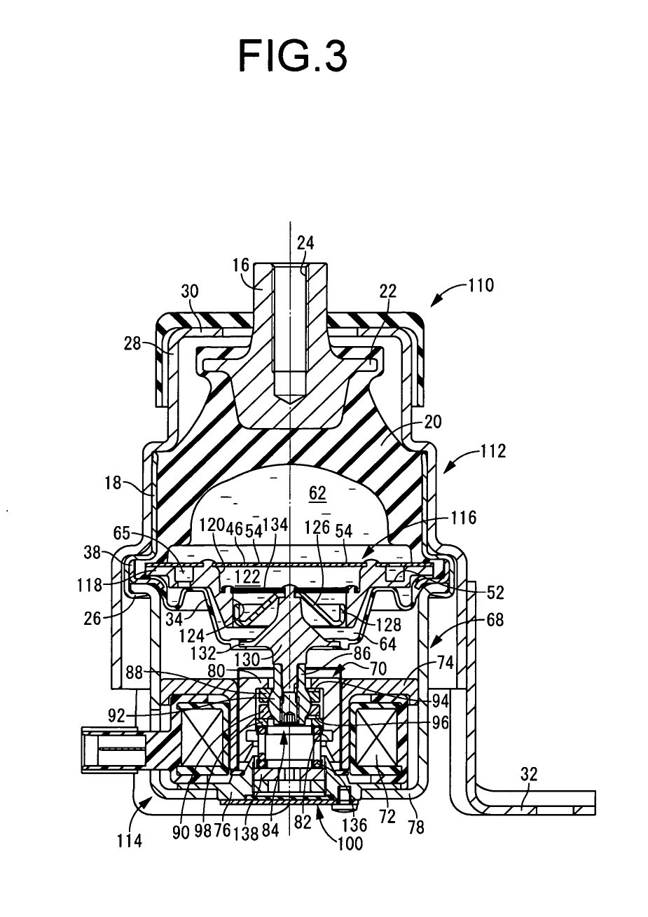

Referring next to FIG. 3, there is depicted an automotive engine mount 110 as a second embodiment of the fluid-filled type active vibration damping device of construction according to the present invention. The engine mount 110 includes a mount body 112 and an electromagnetic actuator 114. In the following description, components and parts that are substantially identical with those in the preceding first embodiment will be assigned like symbols in the drawings and not described in any detail.

To describe in more detail, the mount body 112 is furnished with a partition member 116. The partition member 116 has a generally circular disk shape overall and includes a partition member body 118 and a cover fitting 46.

The partition member body 118 has a thick, generally circular disk shape, with its diametrical center section projecting downward so as to be thick-walled. In the diametrical center section of the partition member body 118 there is formed a circular center recess 120 that opens onto the upper face. The cover fitting 46 is superposed against and fastened to the upper face of the partition member body 118, so that the opening of the center recess 120 is covered with the cover fitting 46.

The partition member 116 of the above construction is disposed within the fluid-filled zone so as to extend in the axis-perpendicular direction. A pressure-receiving chamber 62 and an equilibrium chamber 64 are formed in opposition to either side of the partition member 116. An excitation chamber 122 is formed between the partition member body 118 and the cover fitting 46 utilizing the center recess 120. The excitation chamber 122 communicates with the pressure-receiving chamber 62 via through-holes 54 provided to the cover fitting 46.

In the diametrical center section of the partition member body 118, a circular center hole 124 is formed perforating the bottom wall of the center recess 120 in the axial direction so that the equilibrium chamber 64 and the excitation chamber 122 communicate with each other in the axial direction. The center hole 124 provides the partition member body 118 with generally annular contours and the inside peripheral face of the partition member body 118 defines a tubular guide face for guiding an oscillation member 126 (described later) in the axial direction.

The oscillation member 126 is disposed in the center hole 124 of the partition member body 118. The oscillation member 126 has a generally circular disk shape overall and its diametrical middle section has a tapered shape that slopes gradually downwardly towards its outer peripheral side. At the outer peripheral edge of the oscillation member 126 there is integrally formed a tubular guide portion 128 projecting axially upwardly. With the oscillation member 126 disposed within the center hole 124 of the partition member body 118, the equilibrium chamber 64 and the excitation chamber 122 are separated by the oscillation member 126, and the wall of the excitation chamber 122 is partially defined by the oscillation member 126. The oscillation member 126 is a rigid piston member formed of metal such as iron or aluminum alloy, or of rigid synthetic resin, or of rubber or the like. Whereas there is a tiny gap formed diametrically between the partition member body 118 and the oscillation member 126, fluid flow through the gap is limited to the level that does not pose any problems in terms of vibration damping ability.

A shaft member 130 is attached to the oscillation member 126. The shaft member 130 is a rigid member of generally rod shape extending in the axial direction. The axial upper end of the shaft member 130 is secured to the diametrical center section of the oscillation member 126. A flange-shaped anchor portion 132 is integrally formed with the axial medial portion of the shaft member 130 and extends to the outer peripheral side. The center section of a diaphragm 34 is bonded by vulcanization to the anchor portion 132. The lower end of the shaft member 130 has a bolt structure with a thread having been cut on its outside peripheral face.

The oscillation member 126 and the shaft member 130 are elastically connected to the partition member body 118 by a plate spring 134. The plate spring 134 has a structure in which a plurality of metal springs having a generally circular disk shape are laminated in the thickness direction. While not shown explicitly in the drawings, there are formed one or several communicating holes piercing the plate spring 134 in the thickness direction. The outer peripheral edge of the plate spring 134 is superposed against the bottom wall of the center recess 120 of the partition member body 118, while the diametrical center of the plate spring 134 is superposed against the oscillation member 126 from the above and detained by caulking together with the oscillation member 126 by the upper end portion of the shaft member 130. By so doing, the oscillation member 126 and the shaft member 130 are elastically connected to the partition member body 118, and are elastically held positioned in the axial direction by means of resilient force of the plate spring 134.

Meanwhile, the electromagnetic actuator 114 including a stator 68 and a movable member 70 is disposed below the mount body 112 and connected to a second mounting member 18. With the mount body 112 and the electromagnetic actuator 114 connected to each other, the shaft member 130 of the mount body 112 is attached to the movable member 70 of the electromagnetic actuator 114 via a ball joint 84. As in the first embodiment described previously, after defining the relative position and tilt angle of the shaft member 130 and the movable member 70, a fastening ring 98 is secured press-fit into the movable member 70. With this arrangement, the shaft member 130 and the movable member 70 are prevented from undergoing swinging and displacement in the axis-perpendicular direction relative to each other.

A coil spring 136 is disposed below the fastening ring 98. The coil spring 136 is positioned so that its center axis is approximately aligned with the center axis of the electromagnetic actuator 114, and is interposed between the axially opposed faces of a fastening ring 98 fixed to the movable member 70 and a supporting fitting 138 fixed to the stator 68. The supporting fitting 138 is a member of generally circular disk shape with a thread having been cut on its outside peripheral face, and is threaded into a lower yoke fitting 76 with a thread having been cut on its inside peripheral face. By so doing, the coil spring 136 is pre-compressed by a prescribed amount in the axial direction, whereby reaction force in the axial direction acts across the stator 68 and the movable member 70.

Additionally, the axial position of the supporting fitting 138 is variable within the center hole of the lower yoke fitting 76. Thus, by adjusting the axial position of the supporting fitting 138, it is possible to adjust the amount of pre-compression of the coil spring 136 so as to adjust the level of the reaction force exhibited by the coil spring 136. In this respect, the axial position of the movable member 70 is established owing to the balance between urging force of the coil spring 136 and urging force of the liquid pressure (wall spring rigidity) and the plate spring 134. Therefore, the axial position of the movable member 70 is adjusted according to the axial position of the supporting fitting 138. With this arrangement, the size of the magnetic gap (the distance between the axially opposed faces) formed between the movable member 70 and the stator 68 is variable by adjusting the axial position of the supporting fitting 138. The supporting fitting 138 has a through hole with a hexagonal cross section, so that the supporting fitting 138 can be threaded into the lower yoke fitting 76 in an appropriate position with a hexagon pin spanner. In addition, an annular lock fitting is threaded into the center hole of the lower yoke fitting 76 from below against the supporting fitting 138, thereby preventing the supporting fitting 138 from becoming dislodged in the downward direction. Moreover, a base plate member 100 is screw-fastened to the lower yoke fitting 76, so that the axial position of the supporting fitting 138 can be readjusted by detaching the base plate member 100.

The engine mount 110 of this construction according to the present embodiment, similar to the engine mount 10 according to the first embodiment, is capable of improving reliability of operation, exhibiting desired oscillating ability in a stable manner, improving durability by virtue of prevention of seizing or sliding contact, improving transmission efficiency of the oscillation force, or the like.

Additionally, by employing the coil spring 136 and the supporting fitting 138 for supporting the coil spring 136, the axial gap between the movable member 70 and the stator 68 can be adjusted after assembly of the mount body 112 and the electromagnetic actuator 114. Thus, it is possible to attain an intended oscillation force with a higher degree of accuracy.

While the present invention has been described hereinabove in terms of certain preferred embodiments, the invention shall not be construed as limited in any way to the specific disclosures in the embodiments. For example, it would also be acceptable to form an engine mount of construction according to the present invention with a combination of the mount body 12 as shown in the first embodiment and the electromagnetic actuator 114 as shown in the second embodiment. With this arrangement, support load of the shaft member 36 and the movable member 70 acting on the supporting rubber elastic body 60 will be distributed by the coil spring 136, thereby improving durability of the supporting rubber elastic body 60. It is also to be understood that a combination of the mount body 112 as shown in the second embodiment and the electromagnetic actuator 14 as shown in the first embodiment is employable as well.

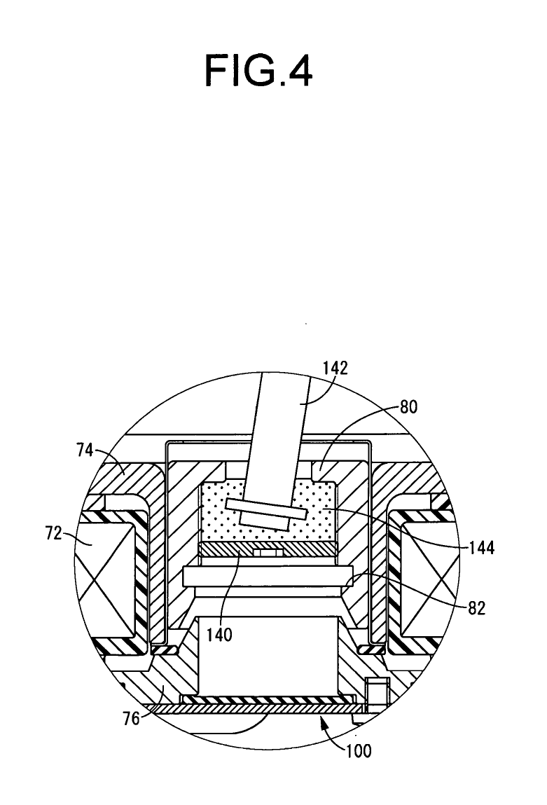

In the first and second embodiments, in order to prevent displacement of the movable member 70 and the shaft member 36, fastening ring 98 is employed serving as the displacement preventing portion and is press-fitted into the movable member 70, thereby increasing frictional resistance. However, the displacement preventing portion is not limited to the construction utilizing frictional resistance. For instance, the displacement preventing portion could also be realized by filling the connecting portion of the shaft member 36 and the movable member 70 (the ball joint 84 in the preceding first and second embodiments) with adhesive, molten metal, brazing solder, or the like to be concreted so as to undisplacably secure the connecting portion of the shaft member 36 and the movable member 70. Described more specifically, the construction such as shown in FIG. 4 would be employable. Namely, a screw lid member 140 of circular disk shape is threaded into the movable member 70 so as to form a prescribed space between the axially opposed faces of the screw lid member 140 and the mating projection 80. The lower end of a shaft member 142 is loosely slid to the inner peripheral side of the movable member 70 to be inserted into the space. Then, the space may be filled with an adhesive 144 to be concreted so that the shaft member 142 is secured to the movable member 70, thereby achieving the displacement preventing portion. In the construction as shown in FIG. 4, a flange-shaped projecting portion is integrally formed with the lower end of the shaft member 142 inserted into the movable member 70, ensuring a sufficient bonding area by the adhesive 144. As to the way of fastening the member for holding the adhesive 144 to the connecting portion of the shaft member 142 and the movable member 70 (the screw lid member 140 in FIG. 4), it may alternatively be possible to employ press fitting for example into the movable member 70. The member corresponding the screw lid member 140 may be omitted by using instant adhesive or the like.

Moreover, the specific structure of the connecting portion should not be construed as limited to the ball joint 84 taught in the first and second embodiments. For instance, in the construction as shown in FIG. 4, the connecting portion is realized by permitting the shaft member 142 and the movable member 70 to swing and displace in the axis-perpendicular direction relative to each other prior to concretion of the adhesive 144.

The scope of the present invention is not limited to engine mounts for automotive applications, and may be implemented in engine mounts for train cars, motorized two wheeled vehicles, or the like. Nor is the present invention limited to engine mounts only, and would be adaptable to implementation in fluid-filled type active vibration damping devices used in various applications such as body mounts, sub-frame mounts, or the like.

What is claimed is:

1. A fluid-filled type active vibration damping device comprising:
a vibration damping device main unit having a first mounting member and a second mounting member connected with each other by a main rubber elastic body, and a fluid chamber whose wall is partially defined by the main rubber elastic body and filled with a non-compressible fluid;
an oscillation member defining another portion of the wall of the fluid chamber;
an actuator disposed on an opposite side of the fluid chamber with the oscillation member being interposed therebetween and attached to the vibration damping device main unit, while being adapted to apply actuating force to the oscillation member and bring about excited displacement of the oscillation member, the actuator being constituted by an electromagnetic actuator having a stator that includes a coil fixed to the second mounting member while having a movable member linearly displaceable relative to the stator when the coil is energized;
a shaft member provided for connecting the movable member and the oscillation member with each other;
a connecting portion provided for attaching the shaft member to the movable member while permitting the shaft member to tilt as well as to undergo displacement in an axis-perpendicular direction with respect to the movable member; and
a displacement preventing portion provided for fastening the movable member and the shaft member to each other by preventing tilt as well as displacement in the axis-perpendicular direction due to the connecting portion.

2. The fluid-filled type active vibration damping device according to claim 1, wherein the connecting portion comprises a ball joint having a bearing inner ring and a bearing outer ring which are allowed to experience relative swinging; the bearing inner ring of the ball joint is provided to the shaft member while the bearing outer ring is inserted into the movable member of tubular shape and supported so as to be capable of relative displacement in the axis-perpendicular direction; the electromagnetic actuator is attached to the vibration damping device main unit; and the bearing inner ring and the bearing outer ring are fixed to each other by the displacement preventing portion while the bearing outer ring is fixed to the movable member.

3. The fluid-filled type active vibration damping device according to claim 2, wherein the bearing inner ring includes a bulging portion whose outside peripheral face is of spherical shape while the bearing outer ring comprises a first ring and a second ring; the first ring and the second ring are fitted externally onto the shaft member from axially opposite sides of the bulging portion; and the first ring and the second ring are fixed to the movable member by being tightened from the axially opposite sides of the bulging portion by the displacement preventing portion so as to become closer to each other.

4. A method of manufacturing a fluid-filled type active vibration damping device that includes a vibration damping device main unit having a first mounting member and a second mounting member connected with each other by a main rubber elastic body, and a fluid chamber whose wall is partially defined by the main rubber elastic body and filled with a non-compressible fluid; an oscillation member defining another portion of the wall of the fluid chamber; an actuator disposed on an opposite side of the fluid chamber with the oscillation member being interposed therebetween and attached to the vibration damping device main unit, while being adapted to apply actuating force to the oscillation member and bring about excited displacement of the oscillation member, the actuator being constituted by an electromagnetic actuator having a stator that includes a coil fixed to the second mounting member while having a movable member linearly displaceable relative to the stator when the coil is energized; a shaft member provided for connecting the movable member and the oscillation member with each other; a connecting portion provided for attaching the shaft member to the movable member while permitting the shaft member to tilt as well as to displace in an axis-perpendicular direction with respect to the movable member; and a displacement preventing portion provided for fastening the movable member and the shaft member to each other by preventing tilt as well as displacement in the axis-perpendicular direction due to the connecting portion, the method comprising:
a first preparation step in which the first mounting member and the second mounting member are connected with each other by the main rubber elastic body to form the vibration damping device main unit;
a second preparation step in which the stator and the movable member are assembled to form the electromagnetic actuator;
an attachment step in which the electromagnetic actuator is attached to the vibration damping device main unit;
a connection step in which, after the attachment step, the shaft member and the movable member are assembled by the connecting portion while being permitted to tilt as well as to displace in the axis-perpendicular direction relative to each other;
a displacement prevention step in which, after the connection step, the shaft member and the movable member are fastened to each other by the displacement preventing portion so as to be prevented from undergoing displacement relative to each other.
